(19) United States
(12) Patent Application Publication
(10) Pub. No.: US 2025/0095377 A1
(43) Pub. Date: Mar. 20, 2025

(54) INFORMATION PROVIDING SYSTEM, INFORMATION PROVIDING METHOD, AND PROGRAM RECORDING MEDIUM

(71) Applicant: NEC Corporation, Minato-ku, Tokyo (JP)

(72) Inventors: Nobuyuki Tozawa, Tokyo (JP); Keisuke Inoue, Tokyo (JP)

(73) Assignee: NEC Corporation, Minato-ku, Tokyo (JP)

(21) Appl. No.: 18/580,363

(22) PCT Filed: Sep. 30, 2021
(86) PCT No.: PCT/JP2021/036115

§ 371 Date: Jan. 18, 2024

(51) Int. Cl. G06V 20/54; G06T 7/20; G06T 7/70; G06V 40/10; G08G 1/005

(52) U.S. Cl. CPC G06V 20/54; G06T 7/20; G06T 7/70; G06V 40/10; G08G 1/005; G06T 2207/30196; G06T 2207/30236

(57) ABSTRACT

An information providing system according to an aspect of the present disclosure includes: at least one memory configured to store instructions; and at least one processor configured to execute the instructions to: measure a retention amount of pedestrians around an intersection based on images from a camera installed around the intersection; create a first map in which the retention amount of pedestrians around the intersection is represented by a marker on a map of the intersection; and output the first map to a predetermined output destination.

### TECHNICAL FIELD

The present invention relates to an information providing system, an information providing method, and a program recording medium.

### BACKGROUND ART

PTL 1 discloses an intersection information distribution system capable of distributing intersection information only to a vehicle traveling toward an intersection. According to paragraph 0024 of the document, it is described that the intersection information corresponds to indication of a signal (current display state of a traffic light), a traffic jam situation such as a traffic jam length, a traveling state of a vehicle near the intersection, presence of a pedestrian or a bicycle in the intersection, and the like.

PTL 2 discloses an approaching moving object display device capable of detecting approaching information of a moving object that is a blind spot from a host vehicle and displaying the approaching information to a driver. According to the document, the approaching moving object display device has a function of recognizing a pedestrian, a two-wheeled vehicle, an automobile, or the like based on the images from a camera installed at an arbitrary place and displaying the pedestrian, the two-wheeled vehicle, the automobile, or the like on a screen in a vehicle.

PTL 3 discloses an airport surface control system including a display means that displays a traveling route of a moving object in a two-dimensional space of a time axis and an axis representing a position from a start point to an end point of movement.

PTL 4 discloses an intersection monitoring system capable of reducing labor required for monitoring movement of a moving object passing through an intersection.

### CITATION LIST

### Patent Literature

PTL 1: JP 2010-146594 A
PTL 2: JP 2008-059609 A
PTL 3: JP 2006-350445 A
PTL 4: JP 2016-206756 A

### SUMMARY OF INVENTION

### Technical Problem

The following analysis was given by the inventor. There is a need to grasp a retention amount of pedestrians staying in a sidewalk area at an intersection for purposes such as adjusting a control parameter of a signal according to the time of day or the day of a week.

In this regard, in the inventions of the above-described patent documents, it is possible to notify the presence or approach of a moving object near an intersection, but the retention amount of pedestrians is not a measurement target as well as a communication target.

An object of the present invention is to provide an information providing system, an information providing method, and a program recording medium capable of providing a retention amount of pedestrians staying in a sidewalk area at an intersection.

### Solution to Problem

According to a first aspect, there is provided an information providing system including: a retention amount measuring means configured to measure a retention amount of pedestrians around an intersection based on images from a camera installed around the intersection; a map creation means configured to create a first map in which the retention amount of pedestrians around the intersection is represented by a marker on a map of the intersection; and an output means configured to output the first map to a predetermined output destination.

According to a second aspect, there is provided an information providing method including: measuring a retention amount of pedestrians around an intersection based on images from a camera installed around the intersection; creating a first map in which the retention amount of pedestrians around the intersection is represented by a marker on a map of the intersection; and outputting the first map to a predetermined output destination. The method is linked to a specific machine, a device that measures the retention amount of pedestrians at an intersection, using images acquired from a camera.

According to a third aspect, there is provided a program for causing a computer capable of acquiring images from a camera installed around an intersection to execute: a process of measuring a retention amount of pedestrians around the intersection based on the images from the camera; a process of creating a first map in which the retention amount of pedestrians around the intersection is represented by a marker on a map of the intersection; and a process of outputting the first map to a predetermined output destination. The computer program can be recorded in a computer-readable (non-transitory) storage medium. That is, the present invention can also be embodied as a computer program product.

### Advantageous Effects of Invention

According to the present invention, it is possible to provide a retention amount of pedestrians staying in a sidewalk area at an intersection.

### BRIEF DESCRIPTION OF DRAWINGS

FIG. 1 is a diagram illustrating a configuration of an example embodiment of the present invention.

FIG. 2 is a diagram for explaining an operation of an example embodiment of the present invention.

FIG. 3 is a flowchart illustrating a flow of operation according to an example embodiment of the present invention.

FIG. 4 is a diagram illustrating a schematic configuration of a first example embodiment of the present invention.

FIG. 5 is a functional block diagram illustrating a configuration of a server according to the first example embodiment of the present invention.

FIG. 6 is a diagram illustrating an example of a retention amount measured by the server according to the first example embodiment of the present invention.

FIG. 7 is a sequence diagram illustrating an operation of the first example embodiment of the present invention.

FIG. 8 is a diagram illustrating an example of a map created by the server according to the first example embodiment of the present invention.

FIG. 9 is a diagram illustrating another example of a map created by the server according to the first example embodiment of the present invention.

FIG. 10 is a diagram illustrating a schematic configuration of a second example embodiment of the present invention.

FIG. 11 is a functional block diagram illustrating a configuration of a server according to the second example embodiment of the present invention.

FIG. 12 is a diagram illustrating an example of a second map created by the server according to the second example embodiment of the present invention.

FIG. 13 is a sequence diagram illustrating an operation of the second example embodiment of the present invention.

FIG. 14 is a diagram illustrating another example of the second map created by the server according to the second example embodiment of the present invention.

FIG. 15 is a diagram illustrating a schematic configuration of a third example embodiment of the present invention.

FIG. 16 is a functional block diagram illustrating a configuration of a server according to the third example embodiment of the present invention.

FIG. 17 is a diagram illustrating an example of a time distance diagram created by a server according to the third example embodiment of the present invention.

FIG. 18 is a sequence diagram illustrating an operation of the third example embodiment of the present invention.

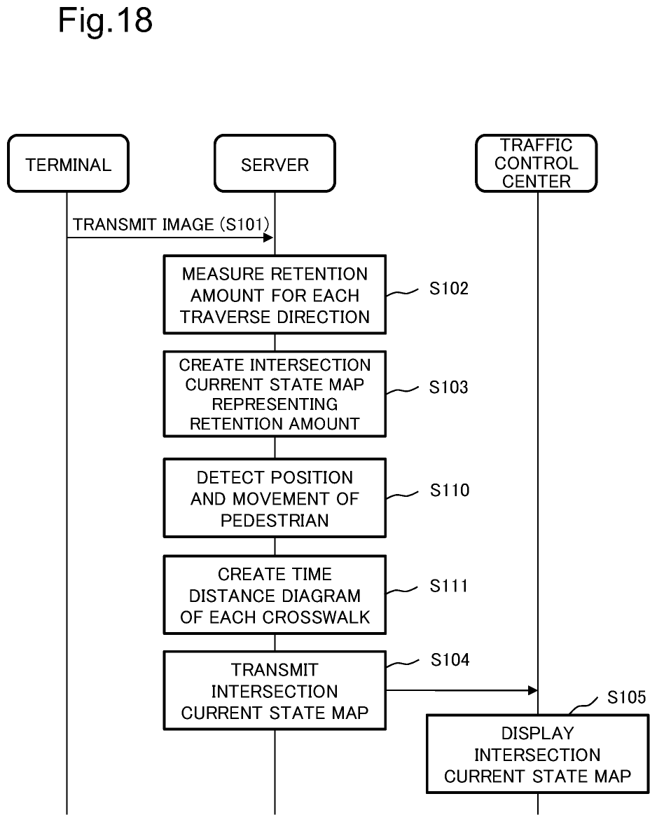

FIG. 19 is a sequence diagram illustrating an additional operation according to the third example embodiment of the present invention.

FIG. 20 is a diagram illustrating an example of a map display switching mode by the server according to the third example embodiment of the present invention.

FIG. 21 is a functional block diagram illustrating a configuration of a server according to a fourth example embodiment of the present invention.

FIG. 22 is a diagram illustrating an example of a time distance diagram created by a server according to the fourth example embodiment of the present invention.

FIG. 23 is a diagram illustrating an example of a map created by a server according to a fifth example embodiment of the present invention.

FIG. 24 is a diagram illustrating a configuration of a computer that can function as a server of the present invention.

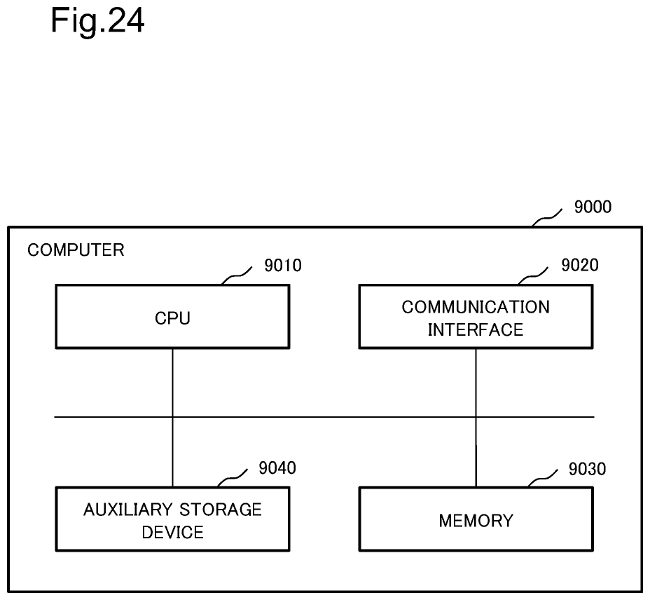

### EXAMPLE EMBODIMENT

First, an outline of an example embodiment of the present invention will be described with reference to the drawings. Note that the reference numerals in the drawings attached to this outline are attached to each element for convenience as an example for assisting understanding, and are not intended to limit the present invention to the illustrated aspects. In addition, connection lines between blocks in the drawings and the like referred to in the following description include both bidirectional and unidirectional. The unidirectional arrow schematically indicates a flow of a main signal (data), and does not exclude bidirectionality. In addition, although there are ports and interfaces at connection points of input and output of each block in the drawing, they are not illustrated.

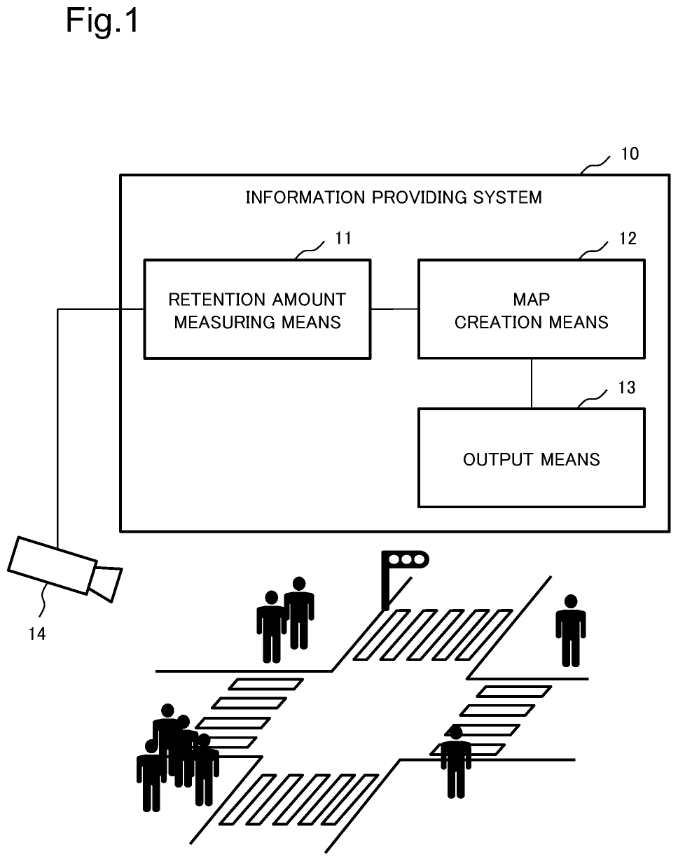

In an example embodiment of the present invention, as illustrated in FIG. 1, the present invention can be realized by an information providing system 10 including a retention amount measuring means 11, a map creation means 12, and an output means 13.

The retention amount measuring means 11 measures the retention amount of pedestrians around an intersection based on images from a camera 14 installed around the intersection. The retention amount of pedestrians can be obtained, for example, by counting the number of pedestrians waiting for a traffic light at a predetermined position of an intersection. The number of pedestrians can be obtained from the number of faces and the number of standing figures of the pedestrians in the images captured by the camera 14. At this time, for example, a moving person who is walking may be excluded from the counting target.

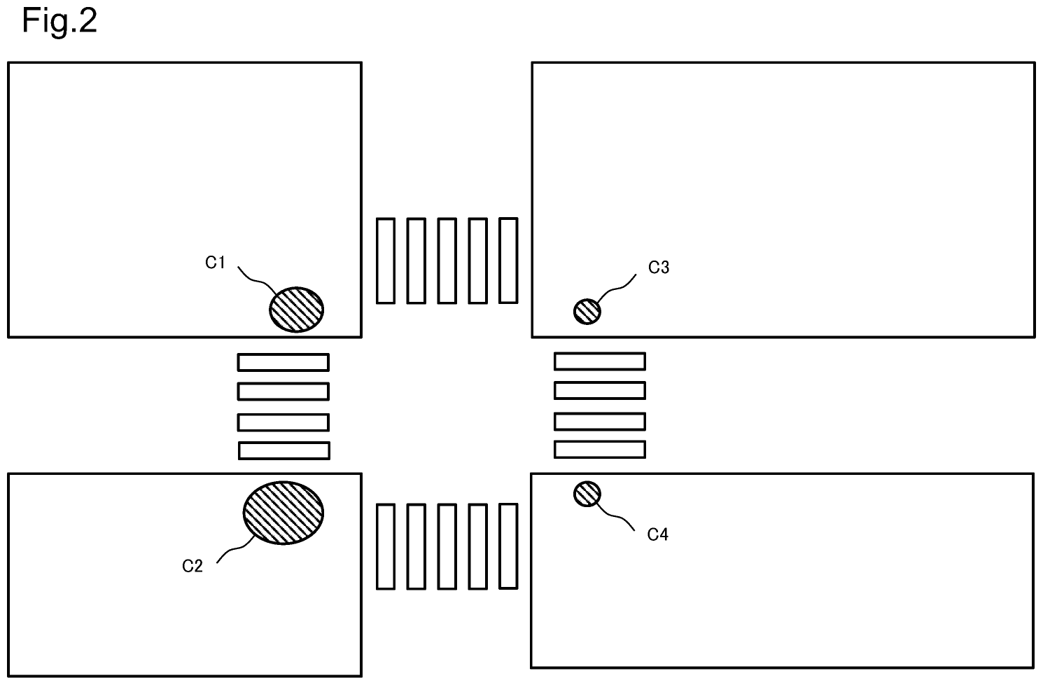

The map creation means 12 creates, on the map of the intersection, a first map in which the retention amount of pedestrians around the intersection is represented by a marker. FIG. 2 is a diagram illustrating an example of a first map in which the retention amount of pedestrians at an intersection created by the map creation means 12 is represented by a graph. As illustrated in FIG. 2, the retention amount of pedestrians can be represented using circular markers C1 to C4 indicating the occurrence position and the amount of retention by the position and the size of a circle. The sizes of the markers C1 to C4 in FIG. 2 correspond to the retention amount of pedestrians at the intersection in the lower part of FIG. 1. Specifically, in the example of FIG. 1, two pedestrians stay at the upper left corner, four pedestrians stay at the lower left corner, one pedestrian stays at the upper right corner, and one pedestrian stays at the lower right corner of the lower intersection. By representing this by the size of the marker as in FIG. 2, it is easy to grasp that a pedestrian is staying on the right crosswalk at the intersection of FIG. 2. The display mode as illustrated in FIG. 2 is also referred to as a bubble chart.

The output means 13 outputs the first map to a predetermined output destination. As the predetermined output destination, a terminal of a traffic control center that monitors an intersection, a vehicle approaching the intersection, an electric display board installed in front of the intersection, and the like can be considered.

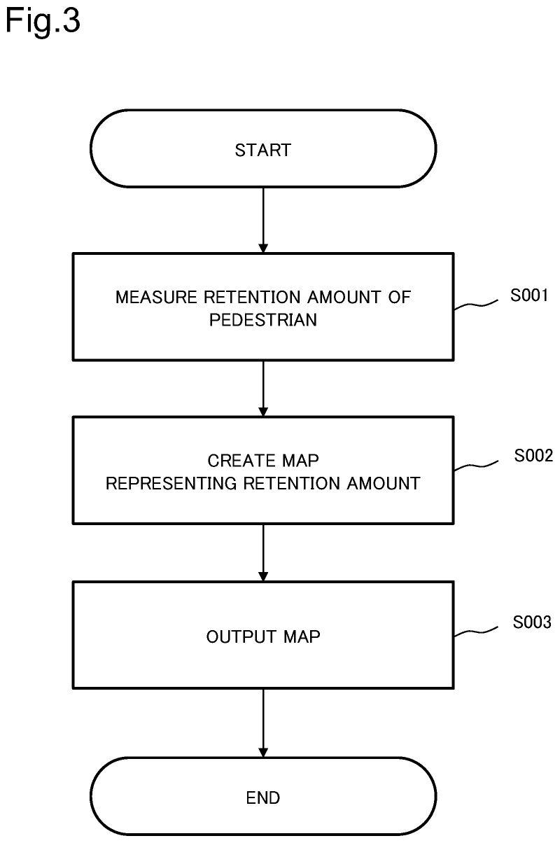

FIG. 3 is a flowchart illustrating a flow of operation of the information providing system 10. As illustrated in FIG. 3, first, the information providing system 10 measures the retention amount of pedestrians around the intersection based on the images from the camera 14 (step S001).

Next, the information providing system 10 creates a first map in which the retention amount of pedestrians around an intersection is represented by a marker on a map of the intersection using the measured retention amount of pedestrians (step S002).

Next, the information providing system 10 outputs the first map to a predetermined output destination (step S003).

According to the information providing system 10 operating as described above, it is possible to notify a user who browses a terminal of a control center, a vehicle approaching the intersection, an electric light display board installed in front of the intersection, and the like of the retention amount of pedestrians at the intersection in a visually easy-to-understand manner.

### First Example Embodiment

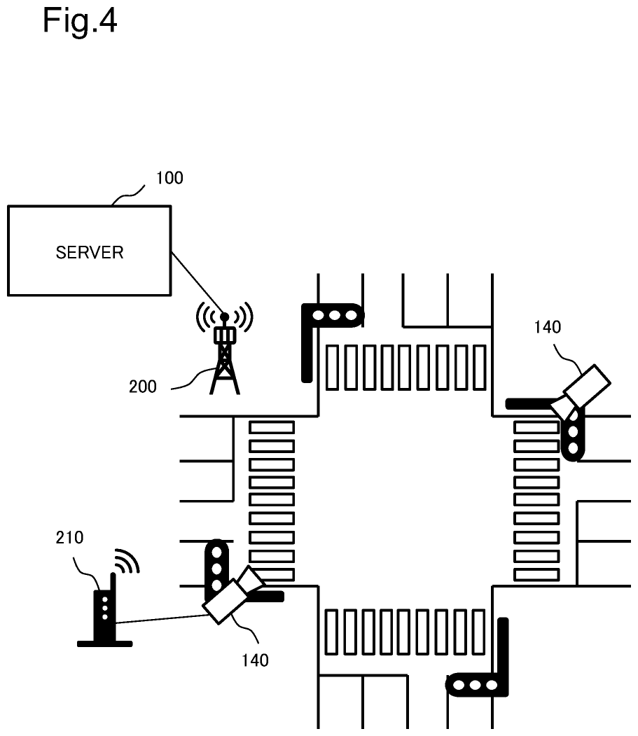

Next, a first example embodiment of the present invention will be described in detail with reference to the drawings. FIG. 4 is a diagram illustrating a schematic configuration of the first example embodiment of the present invention. Referring to FIG. 4, a configuration including a server 100, a base station 200, a terminal 210, and a camera 140 is illustrated.

The camera 140 is a camera installed to image a vehicle or the like passing through an intersection where a crosswalk is installed. In the present example embodiment, the camera 140 is used as a camera for detecting the retention amount of pedestrians at an intersection. Note that, in the example of FIG. 4, an example in which two cameras are arranged to face each other on the diagonal line of the intersection is illustrated, but the number of cameras is not limited. For example, one or more cameras may be installed on each signal pole of a traffic light at an intersection. In addition, in a case where there is a building or a structure near an intersection, a camera may be installed at a position where the intersection can be looked down using the building or the structure, and the camera may be used as a camera for measuring the retention amount.

The terminal 210 is a terminal having a function of wirelessly connecting to the base station 200. In the present example embodiment, the terminal 210 functions as a transmission device that transmits the images captured by the camera 140 to the server 100 via the base station 200. The terminal 210 may be a terminal for traffic control to transmit the images captured by the camera 140 to a traffic control center, a server, or the like via the base station 200.

The base station 200 transmits the camera images received from the terminal 210 to the server 100. In the base station 200, not only the terminal 210 but also an in-vehicle terminal of a vehicle passing near an intersection may be a base station that provides a service to a terminal of a pedestrian. For example, the base station 200 may be a base station of a 5th generation mobile communication system installed by a telecommunication carrier, or may be a base station of a network operated by a person other than the telecommunication carrier called local 5G.

The server 100 is a server that creates a map representing the retention amount of pedestrians at an intersection using the images captured by the camera 140 and transmits the map to a predetermined output destination. The server 100 may be a server installed on a cloud infrastructure or the Internet, or may be a MEC server installed at a position physically close to the base station. Note that “MEC” is an abbreviation for Multi-access Edge Computing or Mobile Edge Computing. In the present example embodiment, a description will be given on the assumption that the server 100 transmits an intersection current state map (first map) representing the retention amount of pedestrians to the traffic control center as a predetermined output destination.

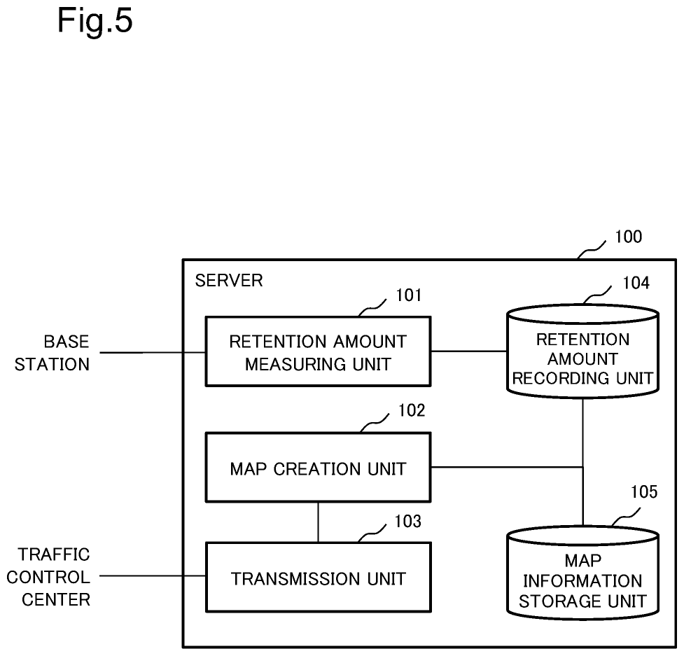

FIG. 5 is a functional block diagram illustrating a configuration of the server 100. Referring to FIG. 5, a configuration including a retention amount measuring unit 101, a map creation unit 102, a transmission unit 103, a retention amount recording unit 104, and a map information storage unit 105 is illustrated.

The retention amount measuring unit 101 functions as a means that measures the retention amount of pedestrians on the sidewalk around the intersection based on the images from the camera 140. Furthermore, the retention amount measuring unit 101 of the present example embodiment groups pedestrians staying in the sidewalk area at the intersection for each position and each transverse direction, and measures the retention amount.

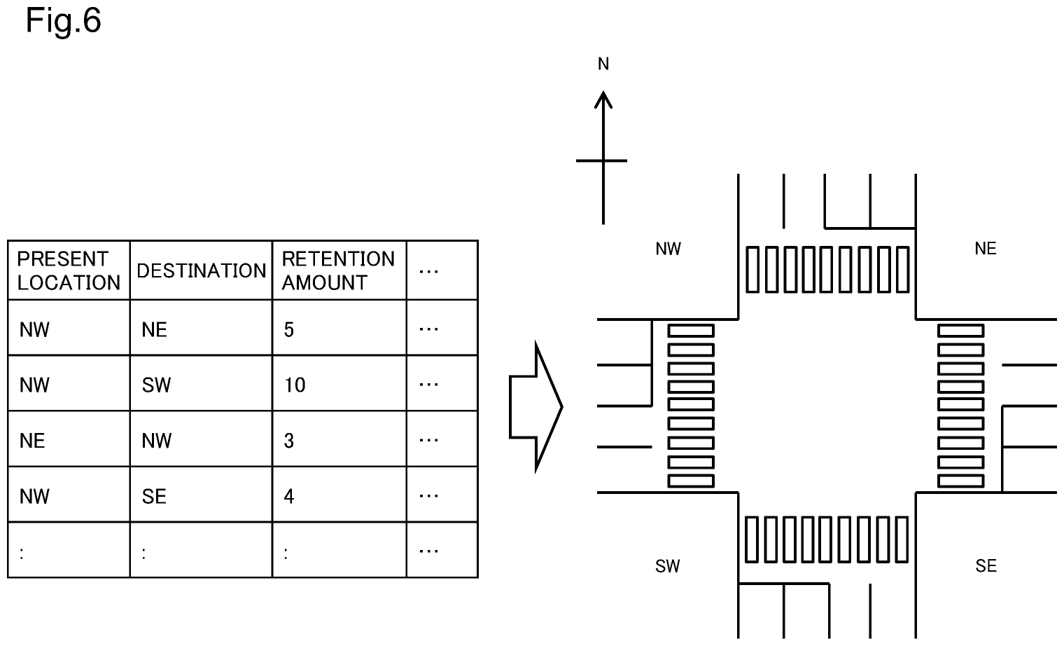

FIG. 6 is a diagram illustrating an example of a recording form of the retention amount measured by the retention amount measuring unit 101. In the example of FIG. 6, the retention amount of pedestrians staying in the sidewalk areas NW, NE, SW, and SE at the corner of the intersection where the road in the east-west direction and the road in the north-south direction intersect is recorded for each destination (transverse direction). For example, it is assumed that fifteen pedestrians stay in the sidewalk area NW at the corner. When five persons among them face the east side, the retention amount in the present location NW to the destination NE is counted as five persons. Similarly, when ten persons out of the fifteen persons face the south, the retention amount in the present location NW to the destination SW is counted as ten persons. Note that the direction of the staying pedestrian can be estimated from the direction of the face and the direction of the line of sight by detecting the face of the pedestrian in the images. As another method, it is also possible to adopt a method of estimating the direction of the staying pedestrian from the posture of the pedestrian or the direction of the body in the images.

The destination may be determined based on the position of the pedestrian instead of the direction of the pedestrian. For example, it is assumed that fifteen pedestrians stay in the sidewalk area NW at the corner. In a case where five of them are located on the east side of the sidewalk area NW, that is, in front of the crosswalk between the corner NW and the corner NE, the retention amount in the present location NW to the destination NE is counted as five persons. Similarly, when ten persons out of the fifteen persons are located on the south side of sidewalk area NW, the retention amount in the present location NW to the destination SW can be counted as ten persons. Note that the position of the staying pedestrian can be determined from the position (for example, the position of the foot of the pedestrian) of the pedestrian in the images by storing the correspondence relationship between the region in the image and the region on the map. As another method, it is also possible to adopt a method of converting an image into a bird's-eye view image and determining a position on a map.

Naturally, the destination of the pedestrian may be determined based on both the direction and the position of the pedestrian. Furthermore, a pedestrian whose destination cannot be determined from these pieces of information may be excluded from the measurement target of the retention amount. For example, it may be determined that a pedestrian who is operating a smartphone or a pedestrian who is looking at an information bulletin board installed at an intersection is not likely to move immediately, and the pedestrian may be excluded from the measurement target of the retention amount.

As illustrated in the table on the left side of FIG. 6, the retention amount recording unit 104 records the retention amount of pedestrians measured as described above. In addition, the retention amount recording unit 104 may hold past data as time-series data for a certain period. By using such time-series data, it is also possible to create a map in which a change in the retention amount of pedestrians can be visually read. For example, the color or movement (animation) of the marker can be used to represent the change in the retention amount. In this way, the server 100 can create the intersection current state map with a larger amount of information.

The map information storage unit 105 stores map information of an intersection to be managed. This map information may be, for example, a plan view of the intersection illustrated on the right side of FIG. 6.

The map creation unit 102 uses the map information of the intersection stored in the map information storage unit 105 and the data indicating the retention amount of pedestrians recorded in the retention amount recording unit 104 to create an intersection current state map in which the retention amount of pedestrians is represented by a marker. A specific operation of the map creation unit 102 will be described later in detail with reference to the drawings.

The transmission unit 103 transmits the intersection current state map to the traffic control center. Note that various modes can be considered as a transmission mode of the intersection current state map to the traffic control center by the transmission unit 103. For example, the transmission unit 103 may transmit the intersection current state map to the traffic control center every time the intersection current state map is created (updated). Furthermore, the transmission unit 103 can also adopt a mode of transmitting an intersection current state map in response to a request from the traffic control center.

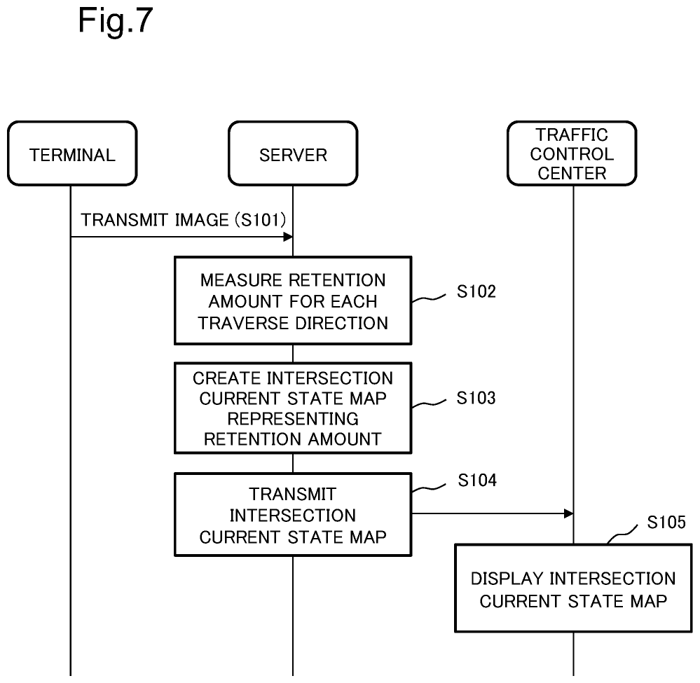

Next, the operation of the present example embodiment will be described in detail with reference to the drawings. FIG. 7 is a sequence diagram illustrating the operation of the first example embodiment of the present invention. Referring to FIG. 7, the terminal 210 transmits the images received from the camera 140 to the server 100 via the base station 200 (step S101).

The server 100 that has received the images groups pedestrians staying in the sidewalk area at the intersection for each transverse direction based on the received images, and measures the retention amount (step S102).

Next, the server 100 creates an intersection current state map by arranging markers on the map of the intersection where the retention amount has been measured and plotting the retention amount for each transverse direction at each position (step S103).

Next, the server 100 transmits the created intersection current state map to the traffic control center (step S104).

Next, the terminal of the traffic control center displays the intersection current state map received from the server 100 (step S105).

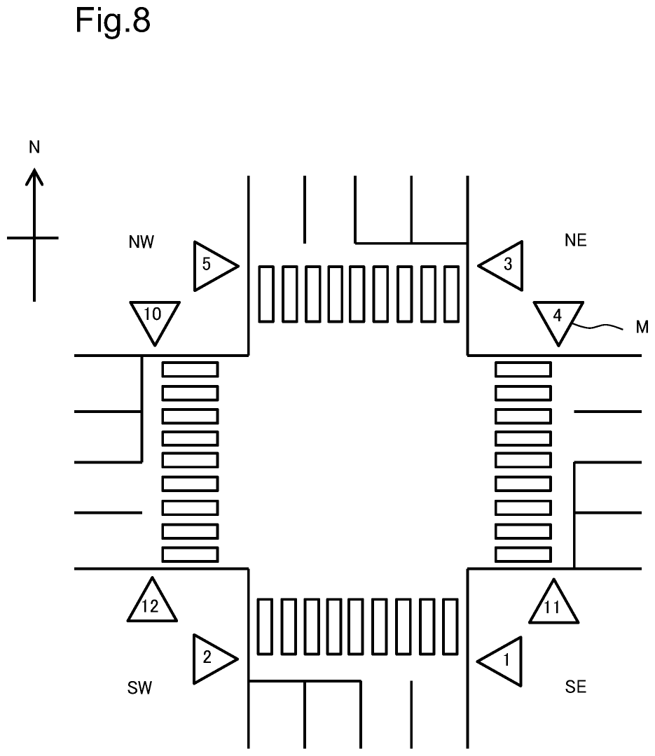

FIG. 8 is a diagram illustrating an example of an intersection current state map (first map) created by the server 100 according to the first example embodiment of the present invention. In the example of FIG. 8, a marker (triangular marker) indicating the retention amount of pedestrians in each transverse direction is illustrated on the map of the intersection. The direction of the marker (triangular marker) indicates the transverse direction, and the numerical value in the marker (triangular marker) indicates the retention amount.

According to such an intersection current state map (first map), it is possible to immediately grasp which crosswalk the pedestrian stays at. For example, in the example of FIG. 8, it can be seen that the number of pedestrians staying at the crosswalk in the north-south direction, particularly between the corners NW and SW, is increased. At this time, in a case where there is no vehicle passing on the road in the east-west direction or in a case where there is a traffic jam and the vehicle is not moving, it is possible to perform control such that the blue display in the east-west direction is quickly cut off and a pedestrian who is going to cross the road in the east-west direction is caused to cross the road in the early stage.

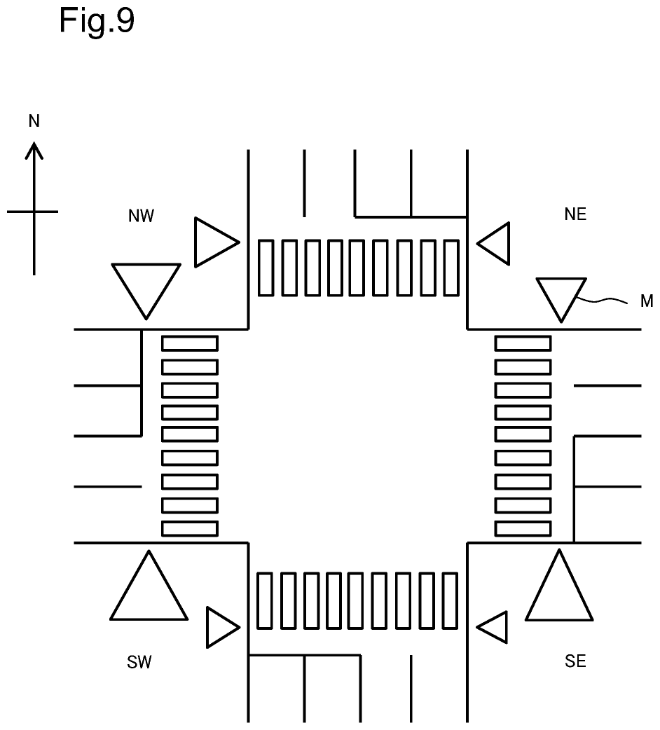

The mode of displaying the retention amount of pedestrians in each transverse direction is not limited to the example of FIG. 8. For example, as illustrated in FIG. 9, the retention amount may be represented by the size of a marker. With the intersection current state map (first map) as illustrated in FIG. 9, it is possible to immediately grasp which crosswalk the pedestrian stays at. In addition to the size of the marker, the retention amount may be represented by changing the color or display form of the marker.

As described above, according to the present example embodiment, it is possible to provide, to the traffic control center, information on the retention amount of pedestrians staying in the sidewalk area at the intersection in each transverse direction, and to use the information for traffic control.

### Second Example Embodiment

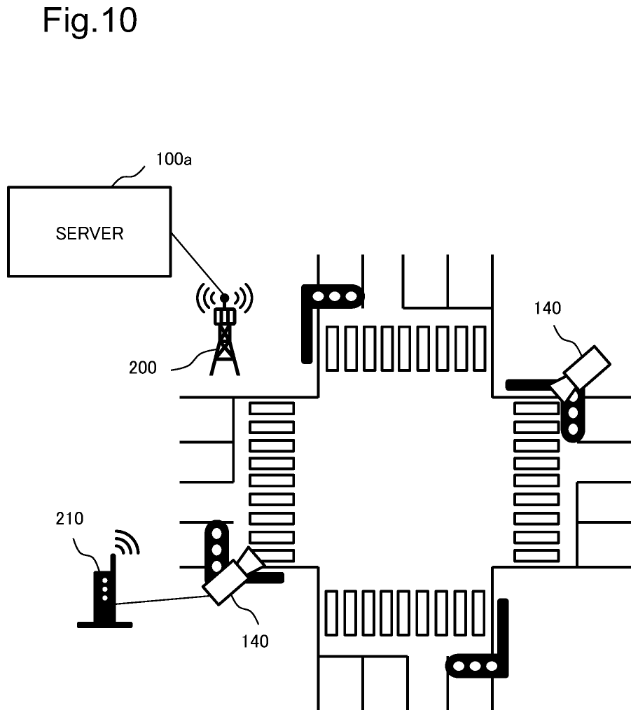

Next, a second example embodiment in which a server detects the position and movement of a pedestrian near an intersection and provides the detected position and movement as a map representing the position and movement of the pedestrian will be described in detail with reference to the drawings. FIG. 10 is a diagram illustrating a schematic configuration of a second example embodiment of the present invention. A configuration difference from the first example embodiment illustrated in FIG. 4 is that a function of detecting a position and a movement of a pedestrian is added to the server 100a. Since the other configurations are equivalent to those of the first example embodiment, the description thereof will be omitted, and the differences will be mainly described below.

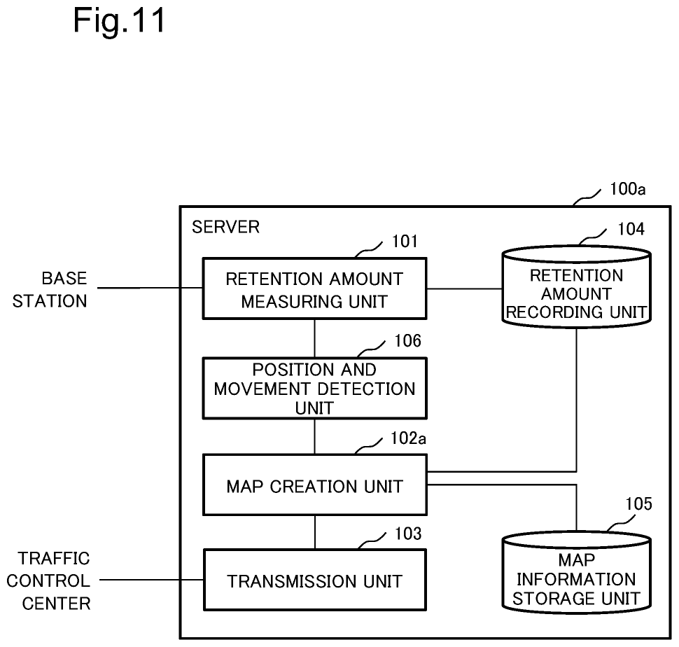

FIG. 11 is a functional block diagram illustrating a configuration of a server 100a according to a second example embodiment of the present invention. Differences from the server 100 of the first example embodiment illustrated in FIG. 5 are that a position and movement detection unit 106 is added to the server 100a, and that the map creation unit 102a can create a second current state map representing the position and movement of the pedestrian.

The position and movement detection unit 106 detects the position and movement of the pedestrian passing through the intersection based on the images from the camera 140. For example, the position and movement detection unit 106 detects the position and movement of each pedestrian by assigning predetermined identification information to each pedestrian appearing in the images from the camera 140 and tracking the movement.

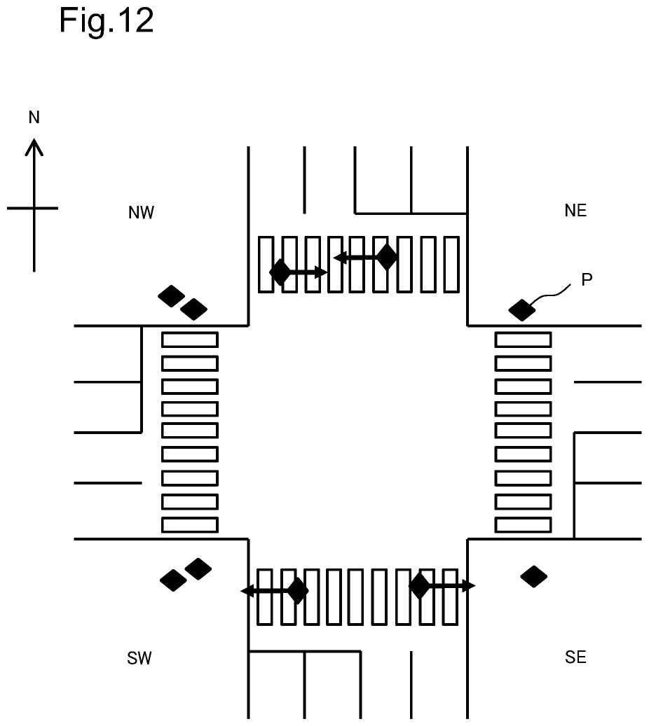

The map creation unit 102a creates a second current map representing the position and movement of the detected pedestrian on a map. FIG. 12 is a diagram illustrating an example of an intersection detail map (second map) created by the map creation unit 102a of the server 100a of the present example embodiment. In the example of FIG. 12, the detected pedestrian is indicated by a diamond-shaped marker. An arrow extending from the diamond-shaped marker indicates the moving direction of the pedestrian. Furthermore, the length of this arrow represents the moving speed of the pedestrian. By using such an intersection detail map (second map), it is possible to grasp not only the retention amount of pedestrians at each intersection but also the tendency of the movement.

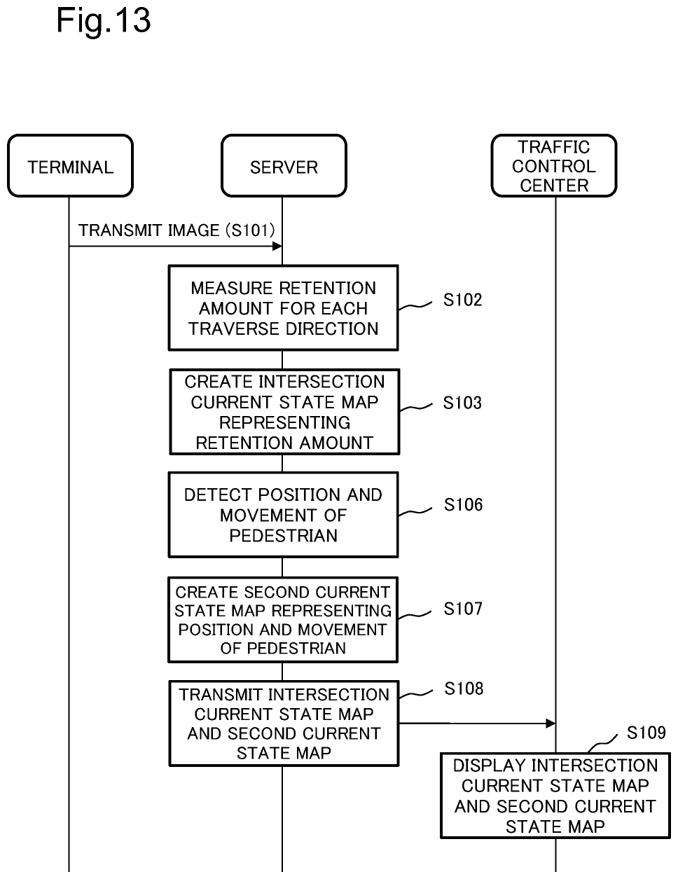

Next, the operation of the present example embodiment will be described in detail with reference to the drawings. FIG. 13 is a sequence diagram illustrating an operation of the second example embodiment of the present invention. Since steps S101 to S103 in FIG. 13 are similar to steps S101 to S103 in FIG. 7 representing the operation of the first example embodiment, the description thereof is omitted.

The server 100a that has created the intersection current state map (first map) representing the retention amount detects the position and movement of the pedestrian (step S106).

Next, the server 100a creates an intersection detail map (second map) representing the position and movement of the pedestrian (step S107).

Next, the server 100a transmits the intersection current state map and the second current map to the traffic control center (step S108).

Next, the terminal of the traffic control center displays the intersection current state map (first map) and the intersection detail map (second map) received from the server 100 (step S109). Note that the display mode of the intersection current state map (first map) and the intersection detail map (second map) in the terminal of the traffic control center can adopt various modes such as a mode of displaying two maps in parallel and a mode of exclusively switching display.

As described above, according to the present example embodiment, it is possible to provide not only the retention amount of pedestrians at the intersection but also information on the movement of the pedestrian to the traffic control center. In particular, according to the second example embodiment, it is possible to finely analyze the contents of the retention amount. For example, as illustrated in FIG. 8, it is assumed that twelve units of pedestrians are found to be staying in the sidewalk area of the corner SW. In the second example embodiment, by providing the intersection detail map (second map), it is possible to distinguish whether the stay is caused by inhibiting the movement of the pedestrian or simply due to a large amount of pedestrian inflow. In the example of FIG. 12, it has been described that the intersection detail map (second map) representing the position and movement of the pedestrian using the arrow is created, but the display mode of the position and movement of the pedestrian is not limited thereto. For example, a line segment may be drawn from the marker, and the direction and length of the line segment may represent the moving direction and speed.

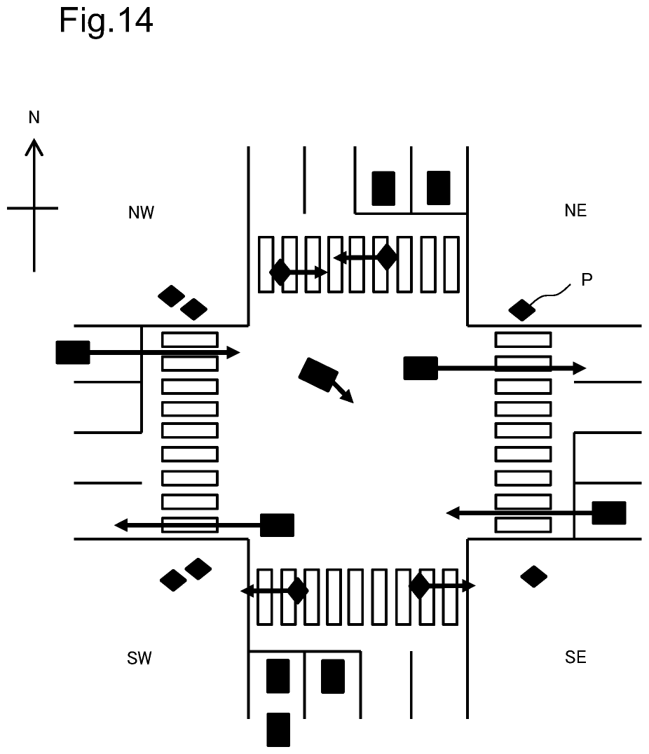

Note that, in the above description, it has been described that the map representing the position and movement of the pedestrian is provided as the intersection detail map (second map). However, a mode in which the server 100a is caused to detect the position and movement of the vehicle passing through the intersection and the position and movement of the vehicle are displayed together with the intersection detail map (second map) can also be preferably employed. FIG. 14 is a diagram illustrating another example of the intersection detail map (second map) created by the server 100a of the present example embodiment. In the example of FIG. 14, the position of the vehicle passing through the intersection is represented by a rectangular marker, and the movement thereof is represented by an arrow. By providing such an intersection detail map (second map), it is possible to grasp the situation of the intersection between the pedestrian and the vehicle, the presence of the pedestrian obstructing the movement of the vehicle, and the like.

Furthermore, in the above-described example embodiment, it has been described that the server 100a measures the retention amount of pedestrians, creates the intersection current state map, then detects the position and movement of the pedestrians, and creates the intersection detail map (second map), but the order thereof can be appropriately changed. In addition, creation and update of the intersection current state map (first map) and the intersection detail map (second map) can be performed independently. For example, in a case where the update frequency of the intersection current state map is different from the update frequency of the second current map, it is also possible to omit the map creation processing with a wider creation interval.

Furthermore, in the above-described example embodiment, the server 100a may create a third current map representing the position of the pedestrian in real time in addition to the second current map, and provide the third current map to the traffic control center. Similarly, the display mode of the third current state map in the terminal of the traffic control center can adopt various modes such as a mode of displaying three maps in parallel and a mode of exclusively switching display.

### Third Example Embodiment

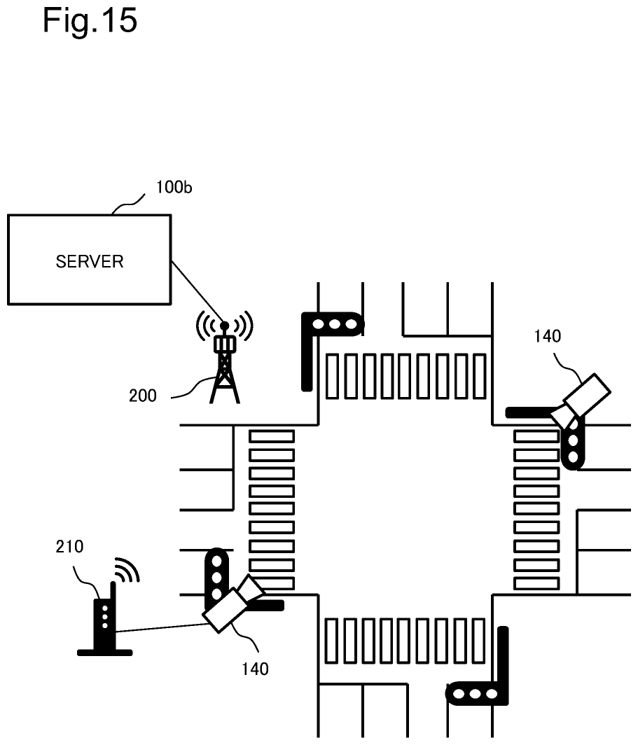

Next, a third example embodiment in which a server can create and provide a time distance diagram of a pedestrian crossing a crosswalk near an intersection will be described in detail with reference to the drawings. FIG. 15 is a diagram illustrating a schematic configuration of a third example embodiment of the present invention. A configuration difference from the first example embodiment illustrated in FIG. 4 is that a function of creating a time distance diagram is added to the server 100a. Since the other configurations are equivalent to those of the first example embodiment, the description thereof will be omitted, and the differences will be mainly described below.

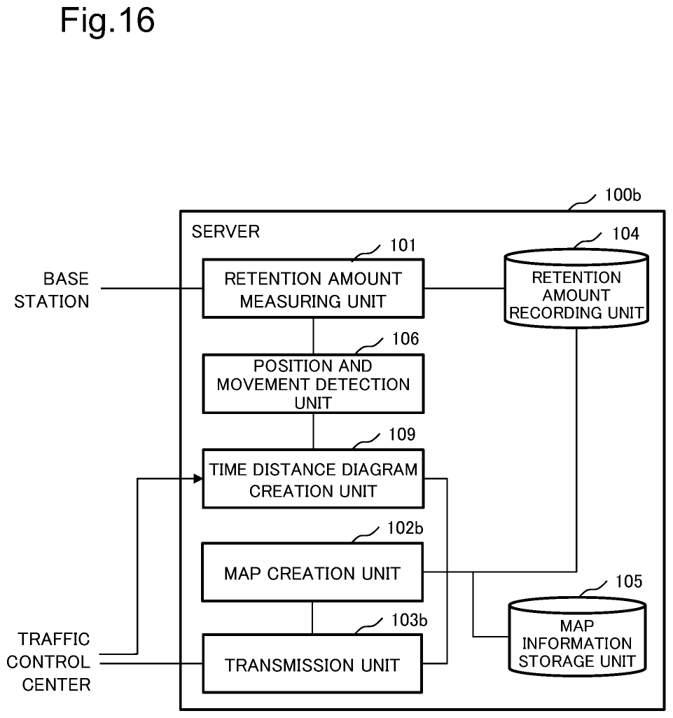

FIG. 16 is a functional block diagram illustrating a configuration of a server 100b according to the third example embodiment of the present invention. Differences from the server 100 of the first example embodiment illustrated in FIG. 5 are that a position and movement detection unit 106 and a time distance diagram creation unit 109 are added to the server 100b, and that the map creation unit 102b and the transmission unit 103b can provide a time distance diagram of a specific crosswalk in response to a request from a traffic control center.

The position and movement detection unit 106 detects the position and movement of a pedestrian passing through a crosswalk at an intersection based on the images from the camera 140. For example, the position and movement detection unit 106 detects the position and movement of each pedestrian by assigning predetermined identification information to each pedestrian appearing in the images from the camera 140 and tracking the movement.

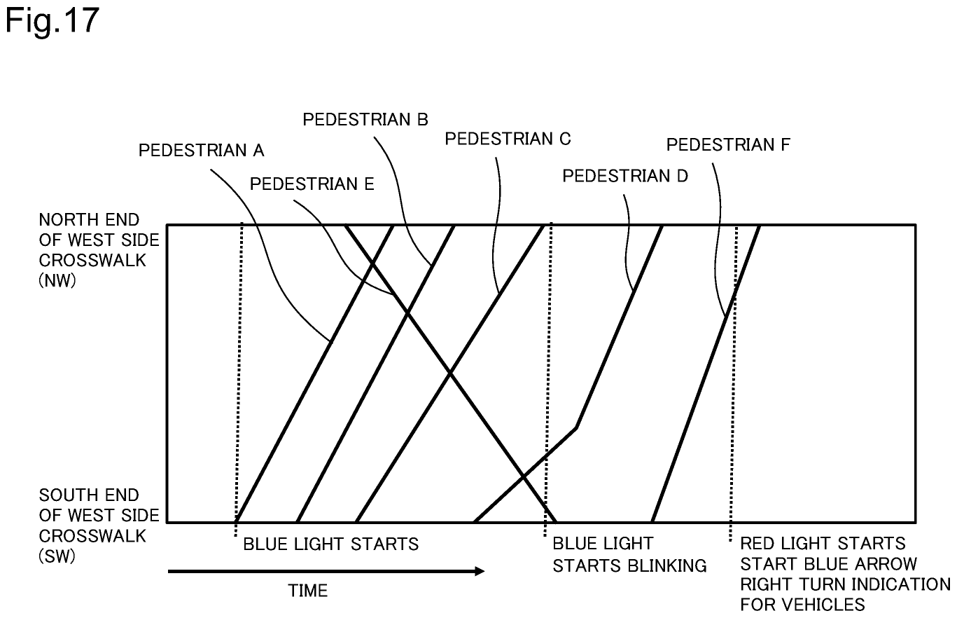

The time distance diagram creation unit 109 creates a time distance diagram in which the movement situation of the pedestrian crossing each crosswalk at the intersection in the past predetermined period is represented in time series by using the detected position and movement of the pedestrian. FIG. 17 is a diagram illustrating an example of a time distance diagram created by the time distance diagram creation unit 109. In FIG. 17, the vertical axis represents the position of a pedestrian crossing a crosswalk at an intersection, and the horizontal axis represents time. For example, it can be seen that pedestrian A in FIG. 17 starts moving from the corner SW to the sidewalk area at the corner NW using the crosswalk at the same time as the start of the blue display of the pedestrian signal. Also in the time distance diagram of FIG. 17, it can be seen that pedestrian D started crossing after a while from when the signal was switched to blue, and then crossed at an increased speed since the signal was switched to blinking in blue. In addition, it can be seen that the pedestrian F started crossing after the signal turned to blink in blue. In this way, the movement of the pedestrian can be more easily grasped by writing the lighting state of the signal together with the time axis of the time distance diagram.

In the example of FIG. 17, the display range is from before the start of blue of the pedestrian signal to the predetermined period after the start of red, but the movement of the pedestrian may be displayed a plurality of times in the past by taking a longer time axis. In this way, it is also possible to grasp the tendency of the behavior of the pedestrian crossing the crosswalk at the intersection. Further, the time axis may be freely changed by the user.

The map creation unit 102b creates an intersection current state map (first map) in which the retention amount of pedestrians is represented by a marker. Specifically, the map creation unit 102b creates an intersection current state map (first map) to which supplementary information for acquiring a time distance diagram corresponding to the position of the marker is added. When receiving the transmission request of the time distance diagram from the terminal of the traffic control center based on the additional information, the transmission unit 103b selects and transmits the corresponding time distance diagram to the terminal of the traffic control center.

Next, the operation of the present example embodiment will be described in detail with reference to the drawings. FIG. 13 is a sequence diagram illustrating an operation of the second example embodiment of the present invention. Since steps S101 to S105 in FIG. 13 are similar to steps S101 to S105 in FIG. 7 representing the operation of the first example embodiment, the description thereof is omitted. In the present example embodiment, step S110 for detecting the position and movement of the pedestrian crossing the crosswalk is added between step S103 and step S104.

Furthermore, in the present example embodiment, a step of creating a time distance diagram based on the detected position and movement of the pedestrian is added (step S111).

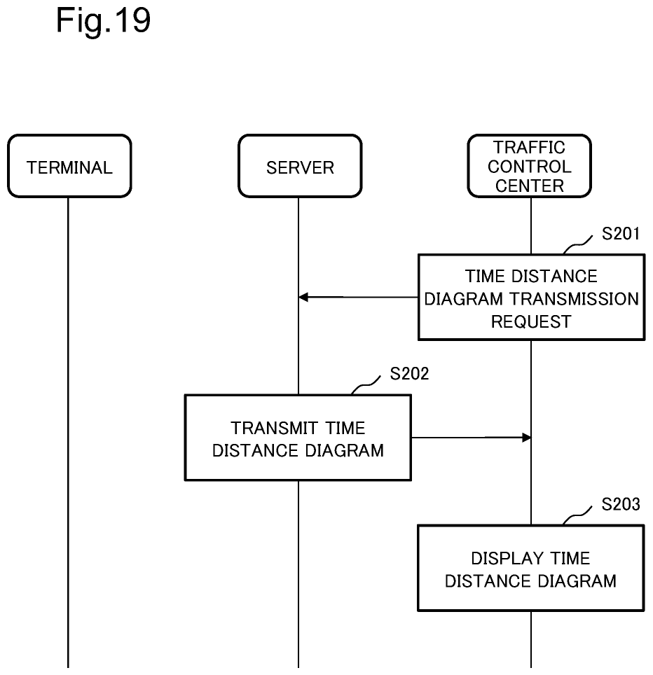

FIG. 19 is a sequence diagram illustrating the additional operation of the present example embodiment. When the selection operation of the marker indicating the retention amount is performed in the terminal of the traffic control center displaying the intersection current state map (first map), the terminal of the traffic control center transmits a request of a time distance diagram including selection information of the marker to the server 100b (step S201).

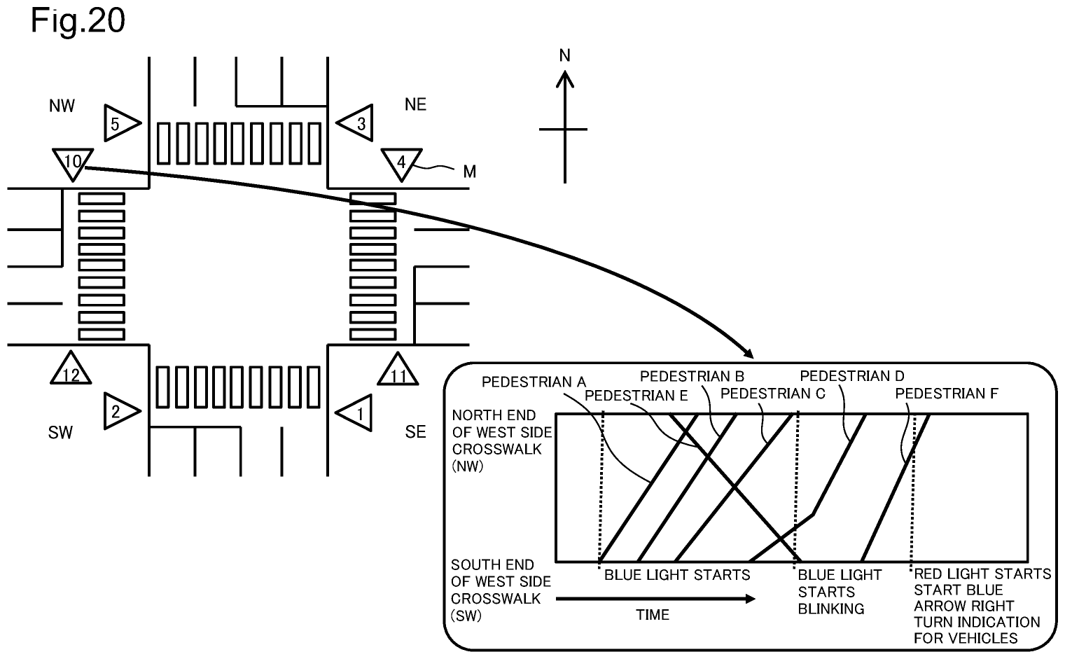

The server 100b that has received the request selects a time distance diagram starting from the position of the marker, and transmits the time distance diagram to the terminal of the traffic control center (step S202). For example, when a marker facing the south, which indicates the retention amount 10 of the sidewalk area in the corner NW in FIG. 20, is selected, the server 100b selects a time distance diagram of the crosswalk between the corner NW and the corner SW, and transmits the time distance diagram to the terminal of the traffic control center.

The terminal of the traffic control center that has received the time distance diagram displays the received time distance diagram (step S203). A display mode of the time distance diagram in the terminal of the traffic control center is not particularly limited. For example, as illustrated in FIG. 20, the time distance diagram may be displayed in a form superimposed on the intersection current state map or in another window. Naturally, it is also possible to adopt an aspect in which the intersection current state map and the time distance diagram are exclusively switched and displayed.

As described above, according to the present example embodiment that displays the time distance diagram in addition to the intersection current state map, it is possible to grasp the movement of the pedestrian at each crosswalk at the intersection in more detail. For example, in the case of a crosswalk at an intersection on a route to an elderly use facility, it is found from the time distance diagram that the walking speed of many users is slow. In this case, it is possible to perform analysis that it is better to increase the time (split) of the green light of the pedestrian signal from the information obtained in the time distance diagram as well as the retention amount.

### Fourth Example Embodiment

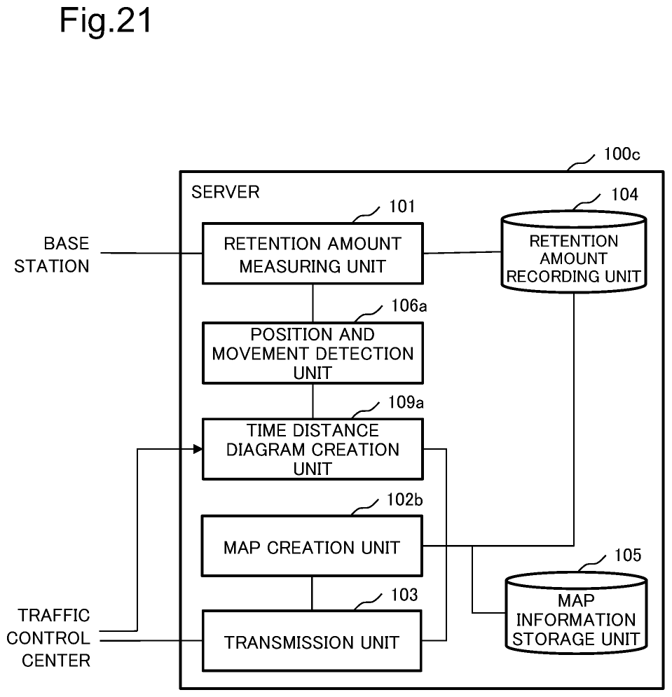

Next, a fourth example embodiment in which a pedestrian attribute analysis function is added to the server of the third example embodiment will be described in detail with reference to the drawings. FIG. 21 is a functional block diagram illustrating a configuration of a server 100c according to the fourth example embodiment of the present invention. A difference from the server 100b of the third example embodiment illustrated in FIG. 16 is that a function of determining an attribute in addition to the position and movement of the pedestrian is added to the position and movement detection unit 106a of the server 100c, and the time distance diagram creation unit 109a can create a time distance diagram for each attribute. Since the other configurations are equivalent to those of the third example embodiment, the description thereof will be omitted, and the differences will be mainly described below.

The position and movement detection unit 106a determines the attribute of the pedestrian such as whether or not to use a movement assisting means such as an electric cart or a cane, and whether or not the pedestrian is an elderly person. These attributes can be determined from the images of pedestrians and feature information in the images obtained by the camera 140.

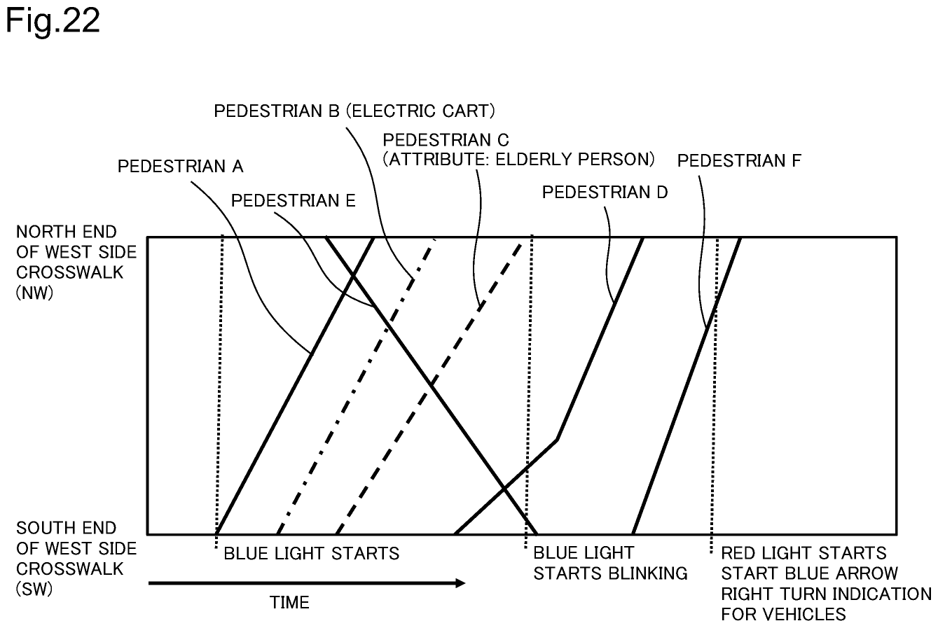

FIG. 22 is a diagram illustrating an example of a time distance diagram created by the time distance diagram creation unit 109a. The difference from the time distance diagram illustrated in FIG. 17 is that the attribute of the pedestrian can be identified by the line type. For example, in a case where it is determined that the electric cart user is represented by a one-dot chain line, it can be seen that the pedestrian B is an electric cart user from the time distance diagram of FIG. 22. In addition, in a case where it is determined that the elderly is represented by a broken line, it can be understood that the pedestrian C is an elderly person from the time distance diagram of FIG. 22.

As described above, according to the present example embodiment that displays the time distance diagram capable of identifying the attribute of the pedestrian, it is possible to grasp the crossing tendency for each attribute in addition to the movement of the pedestrian at each crosswalk at the intersection. The present example embodiment can also be suitably combined with the second example embodiment. For example, a function of creating an intersection detail map (second map) may be added to the server 100c, and the attribute of the pedestrian may be displayed on the intersection detail map (second map). Furthermore, for example, it is also possible to cause the server 100c to create an intersection detail map (second map) displaying pedestrians with markers of different forms and colors according to the attribute of the pedestrians.

### Fifth Example Embodiment

Next, a fifth example embodiment in which a function of measuring a vehicle retention amount is added to the server of the first to fourth example embodiments will be described in detail with reference to the drawings. In the first to fourth example embodiments described above, it has been described that the servers 100 to 100c measures the retention amount of pedestrians, but it is also possible to measure both the retention amount of pedestrians and the retention amount of the vehicle in each lane using a similar mechanism and provide the both to the traffic control center.

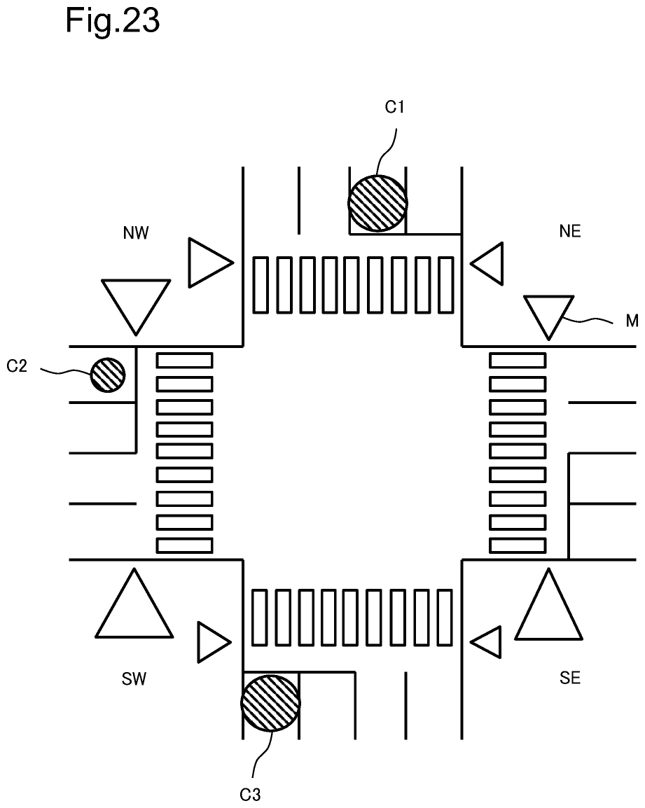

Then, the servers 100 to 100d of the present example embodiment creates an intersection current state map displaying the retention amount of the vehicle in each lane of the road in addition to the retention amount of pedestrians in the sidewalk area. FIG. 23 is a diagram illustrating an example of an intersection current state map created by the servers 100 to 100d according to the fifth example embodiment of the present invention. In the example of FIG. 23, the retention amount of the vehicle is displayed by circular markers C1 to C3 in addition to a triangular marker M indicating the retention amount of pedestrians. In the example of FIG. 23, the sizes of the triangular marker and the circular marker represent the retention amount. As described in the first example embodiment, various modifications can be adopted as the form of the marker and the display form of the size of the retention amount. In the example of FIG. 23, the vehicle retention amount is displayed for each lane of the road, but the vehicle retention amount may be aggregated and displayed between the lanes.

Then, the user of the terminal of the traffic control center can grasp the degree of stay of the vehicles and the pedestrians at the intersection by browsing such an intersection current state map, and can consider and prepare a resolution method as necessary. For example, a vehicle stays (marker C1) in the rightmost right turn lane of the road entering the intersection from the north road in FIG. 23, and a vehicle stays (marker C3) in the leftmost lane of the road entering the intersection from the south road. On the other hand, it can be seen that a pedestrian stays on the crosswalk between the corner NW and the corner SW when these right-turning vehicles turn right. From these facts, it is possible to analyze that many pedestrians cross the crosswalk between the corner NW and the corner SW and obstruct right and left turns of a right turning vehicle and a left turning vehicle.

Note that the features of the second to fourth example embodiments can also be combined with the present example embodiment. Specifically, as in the second example embodiment, a second current map creation function may be added to the server. In this case, in addition to the marker indicating the position and movement of the pedestrian, a marker indicating the position and movement of the vehicle may be displayed on the second current map (see FIG. 16). In addition, as in the third and fourth example embodiments, a function of creating a time distance diagram may be added to the server. In this case, it is also possible to cause the server to detect the position and movement of the vehicle for each lane and create a time distance diagram for each lane. Further, a vehicle attribute determination function may be added to the server to create a time distance diagram that can identify the attribute of the vehicle.

Although the example embodiments of the present invention have been described above, the present invention is not limited to the above-described example embodiments, and further modifications, substitutions, and adjustments can be made without departing from the basic technical idea of the present invention. For example, the configuration of the system, the configuration of each element, and the expression form of data and the like illustrated in the drawings are examples for assisting the understanding of the present invention, and are not limited to the configurations illustrated in the drawings. For example, in the first to fifth example embodiments described above, it has been described that the retention amount of pedestrians is handled, but the retention amount of the bicycle can be modified to be measured and presented in addition to the pedestrian.

Furthermore, in each of the above-described example embodiments, it has been described that the server provides a service to the traffic control center, but the server may provide a service for general vehicles. For example, the server may transmit an intersection current state map or a second current map to a vehicle or the like approaching an intersection. The vehicle that has received the intersection current state map and the second current map displays the intersection current state map and the second current map on a display device or the like of the in-vehicle terminal. The driver can pay attention to the pedestrian with reference to the information indicated in the intersection current state map and the second current map, and can select and travel a lane with less intermingling or traffic congestion with the pedestrian.

In addition, the procedure described in each of the above example embodiments can be realized by a computer that functions as a device constituting the information providing system. Specifically, the present invention can be implemented by a program for causing a computer (9000 in FIG. 19) to implement functions as these devices. Such a computer is exemplified in a configuration including a central processing unit (CPU) 9010, a communication interface 9020, a memory 9030, and an auxiliary storage device 9040 in FIG. 19. That is, the retention amount measurement program and the map creation program may be executed by the CPU 9010 of FIG. 19.

That is, each unit (processing means and function) such as the above-described server can be realized by a computer program that causes a processor mounted in each of these devices to execute each of the above-described processes using the hardware.

Some or all of the above example embodiments may be described as the following supplementary notes, but are not limited to the following.

### [Supplementary Note 1]

(see the information providing system of the first aspect)

### [Supplementary Note 2]

In the information providing system, the retention amount measuring means measures the retention amount of pedestrians in each transverse direction, and the map creation means creates, as the first map, a map in which the retention amount of pedestrians in each transverse direction is represented by a size of the marker on the map of the intersection.

### [Supplementary Note 3]

In the information providing system, the retention amount measuring means estimates a direction of the pedestrian based on the images from the camera, and measures the retention amount of pedestrians in each transverse direction based on the estimated direction of the pedestrian.

### [Supplementary Note 4]

The retention amount measuring means estimates a position of the pedestrian in a region of a sidewalk at the intersection based on the images from the camera, and measures the retention amount of pedestrians in each transverse direction based on the estimated position of the pedestrian in the region of the sidewalk.

### [Supplementary Note 5]

The information providing system further includes a recording means configured to record a measurement result of the retention amount of pedestrians around the intersection as time-series data, and the map creation means creates a map in which a change in the retention amount of pedestrians around the intersection can be read using the time-series data.

### [Supplementary Note 6]

The information providing system further includes a means configured to detect a position and a movement of the pedestrian passing through the intersection based on the images from the camera installed around the intersection, and the map creation means creates, for each of the detected pedestrians, a second map in which an arrow or a line segment indicating the position and the movement of the pedestrian is represented on the map of the intersection.

### [Supplementary Note 7]

The information providing system further includes a unit configured to detect a position and a movement of the pedestrian passing through the intersection based on the images from the camera installed around the intersection; and a time distance diagram creation means configured to create a time distance diagram representing a movement situation of the pedestrian in a past predetermined period of a crosswalk at the intersection in time series, and when the marker on the first map is selected and a predetermined operation is performed, the output means outputs a time distance diagram of a crosswalk at a location indicated by the marker to the predetermined output destination.

### [Supplementary Note 8]

The information providing system further includes a means configured to determine an attribute of a pedestrian passing through the intersection based on images from a camera installed around the intersection, and the time distance diagram creation means creates a time distance diagram in which the attribute of the pedestrian can be identified.

### [Supplementary Note 9]

(see the information providing method of the second aspect)

### [Supplementary Note 10]

(see the program of the third aspect)

Note that the inventions of supplementary notes 9 and 10 can be developed into the inventions of supplementary notes 2 to 8, similarly to supplementary note 1.

Note that the disclosure of the above patent documents is incorporated herein by reference. Within the frame of the entire disclosure (including the claims) of the present invention, it is possible to change and adjust the example embodiments or examples further based on the basic technical idea thereof. In addition, various combinations or selections (including partial deletions) of various disclosure elements (each element of each claim, each element of each example embodiment or example, each element of each drawing, and the like are included) can be made within the frame of the disclosure of the present invention. That is, it is a matter of course that the present invention includes various modifications and corrections that can be made by those skilled in the art in accordance with the entire disclosure including the claims and the technical idea. In particular, for numerical ranges set forth herein, any numerical value or sub-range included within the range should be construed as being specifically described, even if not stated otherwise.

### REFERENCE SIGNS LIST

10 Information providing system
11 Retention amount measuring means
12 Map creation means
13 Output means
14, 140 Camera
100, 100a to 100c Server
101 Retention amount measuring unit
102, 102a, 102b Map creation unit
103, 103b Transmission unit
104 Retention amount recording unit
105 Storage unit
106, 106a Detection unit
109, 109a Time distance diagram creation unit
200 Base station
210 Terminal
9000 Computer
9010 CPU
9020 Communication interface
9030 Memory
9040 Auxiliary storage device
C1 to C4, M, P Marker

What is claimed is:

1. An information providing system comprising:
at least one memory configured to store instructions; and
at least one processor configured to execute the instructions to:
measure a retention amount of pedestrians around an intersection based on images from a camera installed around the intersection;
create a first map in which the retention amount of pedestrians around the intersection is represented by a marker on a map of the intersection; and
output the first map to a predetermined output destination.

2. The information providing system according to claim 1, wherein the at least one processor is further configured to execute the instructions to:
measure the retention amount of pedestrians in each transverse direction, and
create, as the first map, a map in which the retention amount of pedestrians in each transverse direction is represented by a size of the marker on the map of the intersection.

3. The information providing system according to claim 2, wherein the at least one processor is further configured to execute the instructions to:
estimate a direction of the pedestrian based on the images from the camera; and
measure the retention amount of pedestrians in each transverse direction based on the estimated direction of the pedestrian.

4. The information providing system according to claim 2, wherein the at least one processor is further configured to execute the instructions to:
estimate a position of the pedestrian in a region of a sidewalk at the intersection based on the images from the camera; and
measure the retention amount of pedestrians in each transverse direction based on the estimated position of the pedestrian in the region of the sidewalk.

5. The information providing system according to claim 1, wherein the at least one processor is further configured to execute the instructions to:
record a measurement result of the retention amount of pedestrians around the intersection as time-series data; and
create a map in which a change in the retention amount of pedestrians around the intersection can be read using the time-series data as the first map.

6. The information providing system according to claim 1, wherein the at least one processor is further configured to execute the instructions to:
detect a position and a movement of the pedestrian passing through the intersection based on the images from the camera installed around the intersection; and
create, for each of the detected pedestrians, a second map in which an arrow or a line segment indicating the position and the movement of the pedestrian is represented on the map of the intersection.

7. The information providing system according to claim 1, wherein the at least one processor is further configured to execute the instructions to:
detect a position and a movement of the pedestrian passing through the intersection based on the images from the camera installed around the intersection;
create a time distance diagram representing a movement situation of the pedestrian in a past predetermined period of a crosswalk at the intersection in time series; and
when the marker on the first map is selected and a predetermined operation is performed, output a time distance diagram of a crosswalk at a location indicated by the marker to the predetermined output destination.

8. The information providing system according to claim 7, wherein the at least one processor is further configured to execute the instructions to:
determine an attribute of a pedestrian passing through the intersection based on images from a camera installed around the intersection; and
create a time distance diagram in which the attribute of the pedestrian can be identified.

9. An information providing method comprising:
measuring a retention amount of pedestrians around an intersection based on images from a camera installed around the intersection;
creating a first map in which the retention amount of pedestrians around the intersection is represented by a marker on a map of the intersection; and
outputting the first map to a predetermined output destination.

10. A non-transitory program recording medium storing a program for causing a computer capable of acquiring images from a camera installed around an intersection to execute:
a process of measuring a retention amount of pedestrians around the intersection based on the images from the camera;
a process of creating a first map in which the retention amount of pedestrians around the intersection is represented by a marker on a map of the intersection; and
a process of outputting the first map to a predetermined output destination.
